(19) United States
(12) Patent Application Publication
(10) Pub. No.: US 2023/0401729 A1
(43) Pub. Date: Dec. 14, 2023

(54) LINE STRUCTURED LIGHT CENTER EXTRACTION METHOD FOR COMPLICATED SURFACES

(71) Applicant: ZHEJIANG UNIVERSITY, Hangzhou, Zhejiang (CN)

(72) Inventors: Zaixing HE, Hangzhou, Zhejiang (CN); Xinyue ZHAO, Hangzhou, Zhejiang (CN); Lianpeng KANG, Hangzhou, Zhejiang (CN)

(73) Assignee: ZHEJIANG UNIVERSITY, Hangzhou, Zhejiang (CN)

(21) Appl. No.: 18/035,859

(22) PCT Filed: Dec. 5, 2020
(86) PCT No.: PCT/CN2020/134128

§ 371 Date: May 8, 2023

(51) Int. Cl. G06T 7/521

(52) U.S. Cl. CPC G06T 7/521

(57) ABSTRACT

The invention discloses a line structured light center extraction method for complicated object surfaces. The method comprises: selecting a reliable seed point position of a light stripe by an extremum method and a connected domain filtering algorithm; then, calculating an intensity representation value and a deviation representation value at the seed position in a half-cycle 180° direction, synthesizing a score function of the position in all directions by weighting, determining a light stripe direction and an optimal fitting line length at the position according to the score function to generate a next node position, and extracting a center line of the laser stripe by successive growing; and finally, extracting a complete center pixel of the stripe in a local region of the center line by a grayscale centroid method. The method of the invention can quantify light stripe features recognized by human eyes, improves traditional center extraction methods based on a row direction or a local region, and realizes stripe extraction from the global perspective, thus being able to completely extracting center pixels of stripes in complicated interference cases.

### BACKGROUND OF THE INVENTION

### 1. Technical Field

The invention relates to the technical fields of three-dimensional measurement based on computer vision and industrial automation, in particular to a line structured light center extraction method adopted in cases of complicated environments and complicated part surface interference when a line structured light scanning method is used for three-dimensional reconstruction and three-dimensional measurement.

### 2. Description of Related Art

At present, in the field of industrial automation, it is necessary to extract three-dimensional point cloud information of objects in many application scenarios such as gripping of objects stacked out of order and measurement of three-dimensional data of products. Compared with surface structured light scanning, line structured light scanning, as a principle method for acquiring three-dimensional point cloud data, has the advantages of high accuracy and low sensitivity to reflective objects.

In actual application, center extraction of line structured light strips is a key step in the line structured light scanning process, and has a direct influence on the accuracy of an entire system. Particularly in a case where the surface of a measured object is in a dark color or is seriously reflective, or the measurement background interference is strong, the accuracy and robustness of center extraction of the line structured light stripes are unsatisfying.

The study of existing line structured light center extraction algorithms mainly focuses on how to optimize the processing speed and accuracy under the condition of weak background interference. However, there are only a few center extraction algorithms for complicated object surfaces, which makes it impossible to use the line structured light scanning method for industrial application in complicated cases, thus severely limiting specific industrial application scenarios.

In view of application scenarios with complicated object surface interference, the invention considers the features of light stripes from the aspect of overall relevancy of line structured light scan images and quantify and represent the features of line structured light stripes determined by human eyes to fulfill high accuracy and robustness even in complicated cases, thus expanding the application scenarios of line structured light scanning.

### BRIEF SUMMARY OF THE INVENTION

To solve the problems that, in complicated scenarios, pseudo ribbon stripe regions caused by complicated texture and dark stripe regions caused by dark surfaces severely reduce the stripe center extraction effect and it is hard to locally filter out pseudo stripes and detect real stripes, the invention provides a line structured light center extraction method based on laser stripe feature estimation, which has a good interference filter effect and is able to accurately and stably extract the center pixel of line structured light stripes.

To solve the above-mentioned problems, the invention adopts the following technical solution:

A line structured light center extraction method for complicated surfaces comprises the following steps:
Step 1: processing a line structured light image by an extremum method and a connected domain filter method to determine an accurate center point of a laser stripe, and using the accurate center point of the laser stripe as a seed point of a center extraction algorithm;
Step 2: calculating an intensity representation value and a direction deviation representation value at the position of the seed point or a node according to a grayscale of the image in a half-cycle 180° direction, establishing a score function to determine an optimal stripe direction, and determining an optimal stripe fitting length to determine the position of a next node; and
Step 3: extracting all nodes by growing, stopping an iterative operation when the grayscale of the image decreases drastically so as to obtain a center line of a line structured light stripe, and finally, extracting an accurate center point of the light stripe from a local region of the center line by a grayscale centroid method.

In Step 1, a maximum pixel of the light stripe is obtained after the line structured light image is processed by the extremum method, a connected field area is calculated, an interference region with a small area and a reflective region with a width not meeting stripe features are filtered, a connected domain meeting stripe region features is used as a light stripe region, the seed point of the algorithm is selected, and iterative line fitting is performed upwards and downwards respectively.

By performing the above step, a small interference region and a large reflective region can be removed, and some pseudo stripe regions meeting corresponding features are taken as substitutive seed points. After the center line is extracted, multiple parallel center lines from different seed points are determined and estimated according to the length of the center line and connection with other determined center lines, and finally, an optimal center line is determined to ensure that correct seed points are extracted in the above-mentioned cases.

In Step 2, an average grayscale V_{L} of adjacent pixels of a line away from the seed point, used as an initial point, by a distance L in a θ direction is calculated first, and an intensity representation value V_{Q} in this direction is obtained by weighted averaging, as shown by formula (1):

$${V}_{θ} = {\sum }_{L = 1}^{R - 1} \frac{{V}_{L} {f}_{L}}{n} , \qquad ( 1 )$$

Wherein, f_{L}=R−L, n=Σ₁ⁿf_{L}, and based on the stripe width, a constant R is set as 20; V_{θ} represents an intensity feature difference between this direction and a background direction, and the larger the intensity representation value, the larger the intensity feature difference between this direction and the background direction, and the greater the possibility of the stripe direction.

For an excessively dark laser stripe caused by a dark surface, a direction continuity feature value θ_{dev} is established to represent a change of the stripe direction in two successive times of growing, and the smaller the value of the change of the stripe direction, the higher the continuity of the laser stripe, and the greater the possibility of the stripe direction; and finally, the score function is established to calculate extreme points of all intensity feature values, and a stripe direction corresponding to a maximum value of the score function is selected as a growth direction, as shown by formula (2):

$$S = \frac{{v}_{θ}}{{θ}_{dcv}} = \frac{{v}_{θ}}{\vert {θ}_{p} - {θ}_{op} \vert + δ} . \qquad ( 2 )$$

In Step 3, a complete light stripe skeleton can be extracted from each seed point by growing, and when the grayscale of a processed region is extremely low or the degree of attenuation of the intensity representation value during two successive iterations is too large, the iterative operation is stopped to obtain the center line of the light stripe.

The accurate center point of the laser stripe is calculated in a local adjacent region of the obtained stripe center line by the grayscale centroid method. Assume I is a laser stripe image, I(i,j) is the grayscale of a pixel in the i^{th} row and j^{th} column, (i₀,j₀) is pixel coordinates of the obtained center line, and coordinates of an accurate center point of the i₀_{^{th}} column are calculated according to formula (3):

$${Center}_{p} = ( {i}_{0} , \frac{{\sum }_{j = {j}_{0} - 10}^{{j}_{0} + 10} I ( {i}_{0} , j ) \times j}{{\sum }_{j = {j}_{0} - 10}^{{j}_{0} + 10} I ( {i}_{0} , j )} ) . \qquad ( 3 )$$

By adoption of the above technical solution, the invention has the following beneficial effects:

The invention provides a good stripe center extraction scheme that can effectively reduce interference in cases of part surfaces with complicated texture, part surfaces in dark colors and reflective part surfaces in the line structured light scanning process, thus guaranteeing good robustness and stability in the stripe center extraction process.

### BRIEF DESCRIPTION OF THE SEVERAL VIEWS OF THE DRAWINGS

The invention will be further described below with reference to accompanying drawings.

FIG. 1 is a flow diagram of the invention;

FIG. 2 is a calculation diagram of an intensity feature value;

FIG. 3 is a variation diagram of the intensity feature value;

FIG. 4, FIG. 5 and FIG. 6 are effect pictures of a center extraction method according to the invention.

### DETAILED DESCRIPTION OF THE INVENTION

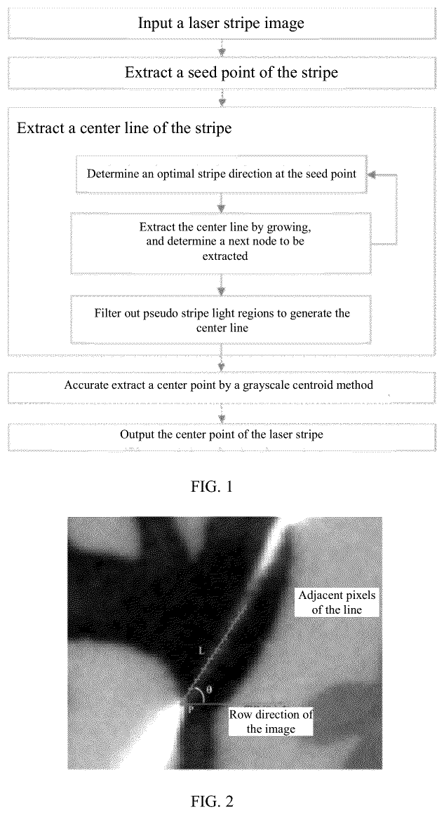

The invention will be further described below in conjunction with the accompanying drawings and embodiments. FIG. 1 illustrates a flow diagram of the invention.

First, a line structured light image is processed by an extremum method and a connected domain filter method by means of strong filter to select a connected domain region best fitting laser stripe features, and the center point of the region is used as a reliable center point of a laser stripe, namely a seed point.

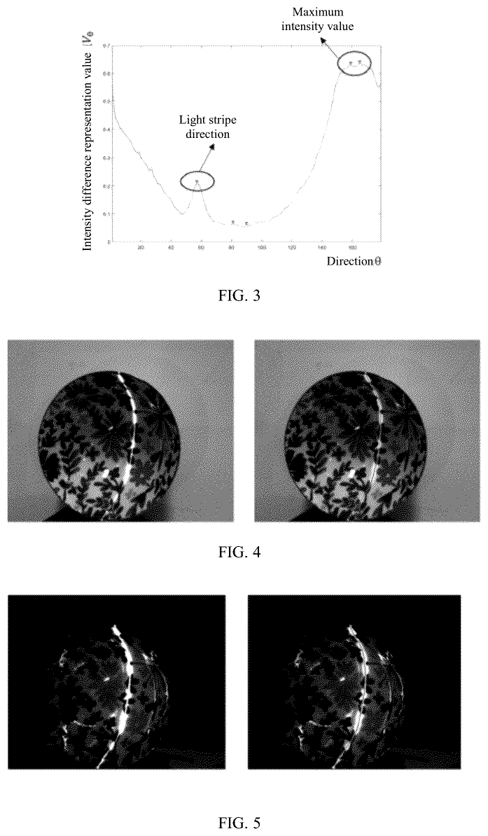

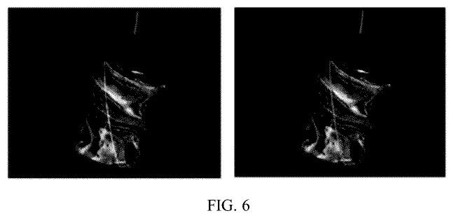

As shown in FIG. 2, an average grayscale of adjacent pixels of a line away from the seed point P, used as an initial point, by a distance of L in a θ direction is calculated, an intensity representation value in this direction is obtained by weighted averaging, and an extreme point of the intensity feature value is selected as a possible stripe direction according to a distinct intensity difference between the direction of the laser stripe and a background region, as shown in FIG. 3. Then, a score function in the possible stripe direction is calculated according to formula (2) to determine an optimal stripe direction, and a next node is determined to perform successive growing for extraction. When the conditions that (1) the intensity feature difference has no obvious extreme point after smoothing and filtering and (2) the intensity feature value is smaller than the background intensity, the growing extraction algorithm is stopped to obtain the center line of the laser stripe.

Finally, the obtained center line is filtered, and a unique center line is determined for each row to eliminate interference on a complicated object surface, and a center point of the laser stripe is extracted by a grayscale centroid method according to formula (3) and is then output.

As can be seen from FIG. 4, FIG. 5 and FIG. 6 which are effect pictures of center extraction of different experimental objects, the method of the invention can effectively filter out interference caused by complicated surfaces in cases of reflection of object surfaces, excessively low laser brightness and complicated texture interference of object surfaces, thus realizing an accurate and robust center extraction effect and fulfilling line structured light measurement in complicated cases.

The above embodiments are merely specific ones of the invention, and are not intended to limit the technical features of the invention. Any simple variations, equivalent substations or embellishments made to solve basically identical technical problems and fulfill basically identical technical effects based on the invention should also fall within the protection scope of the invention.

What is claimed is:

1. Aline structured light center extraction method for complicated surfaces, comprising the following steps: Step 1: processing a line structured light image by an extremum method and a connected domain filter method to determine an accurate reliable center point of a laser stripe, and using the accurate reliable center point of the laser stripe as a seed point of a center extraction algorithm, wherein in Step 1, a maximum pixel of the light stripe is obtained after the line structured light image is processed by the extremum method, a connected field area is calculated, an interference region with a small area and a reflective region with a width not meeting stripe features are filtered, a connected domain meeting stripe region features is used as a light stripe region, and the seed point of the algorithm is selected; by performing this step, a small interference region and a large reflective region are removed, and some pseudo stripe regions meeting corresponding features are taken as substitutive seed points; after the center line is extracted, multiple parallel center lines from different seed points are determined and estimated according to the length of the center line and connection with other determined center lines, and finally, an optimal center line is determined to ensure that a correct number of false seed points are extracted according to the center line in the following cases. Step 2: calculating an intensity representation value and a direction deviation representation value at the position of the seed point or a node according to a grayscale of the image in a half-cycle 180° direction, establishing a score function to determine an optimal stripe direction, and determining an optimal stripe fitting length to determine the position of a next node, wherein in Step 2, to express an intensity difference between the light stripe and a background region, an intensity representation value is established according to features of a high-brightness line laser stripe region, and an intensity extreme point is selected to express a high-brightness feature of the light stripe; for an excessively dark laser stripe caused by a dark surface, a direction continuity feature value θ_{dev} is established to represent a change of the stripe direction in two successive times of growing, and the small the value of the change of the stripe direction, the higher the continuity of the laser stripe, and the greater the possibility of the stripe direction; and finally, the score function is established to calculate extreme points of all intensity feature values, and a stripe direction corresponding to a maximum value of the score function is selected as a growth direction, as shown by the following formula:
$$S = \frac{{v}_{θ}}{{θ}_{dcv}} = \frac{{v}_{θ}}{\vert {θ}_{new} - {θ}_{old} \vert + δ} .$$
Step 3: extracting all nodes by growing, stopping an iterative operation when the grayscale of the image decreases drastically so as to obtain a center line of a line structured light stripe, and finally, extracting an accurate center point of the light stripe from a local region of the center line by a grayscale centroid method.

2. The line structured light center extraction method according to claim 1, wherein in Step 3, a complete light stripe skeleton is extracted from each seed point by growing, and when the conditions that (1) the intensity feature difference has no obvious extreme point after smoothing and filtering and (2) the intensity feature value is smaller than a background intensity, the growing extraction algorithm is stopped to obtain the center line of the laser stripe; and after parallel center lines growing from different seed points are uniquely filtered, the accurate center point of the laser stripe is calculated in local adjacent region of the obtained center line by the grayscale centroid method.
